(19) United States
(12) Patent Application Publication
(10) Pub. No.: US 2026/0131728 A1
(43) Pub. Date: May 14, 2026

(54) VEHICLE NOTIFICATION APPARATUS, METHOD OF CONTROLLING VEHICLE NOTIFICATION APPARATUS, AND RECORDING MEDIUM

(71) Applicant: HONDA MOTOR CO., LTD., Tokyo (JP)

(72) Inventors: Tsuyoshi Nojiri, Wako-shi (JP); Tatsuya Iwasa, Wako-shi (JP); Toshihiro Hashimoto, Wako-shi (JP); Haruko Okuyama, Wako-shi (JP); Yuichiro Shimura, Wako-shi (JP)

(21) Appl. No.: 19/356,519

(22) Filed: Oct. 13, 2025

(30) Foreign Application Priority Data
Nov. 11, 2024 (JP) 2024-196391

(51) Int. Cl. B60Q 9/00

(52) U.S. Cl. CPC B60Q 9/008

(57) ABSTRACT

A vehicle notification apparatus includes: an object detection unit that detects an object existing around a vehicle; a first notification unit that notifies existence of the object around the vehicle to a driver of the vehicle via voice or a sound other than voice; a second notification unit that notifies the existence of the object around the vehicle to the driver via a mode other than voice and the sound; and a decision unit that decides notification order between the first notification unit and the second notification unit, according to a degree of risk of the vehicle coming into contact with the object. The first notification unit and the second notification unit perform notification in accordance with the notification order decided by the decision unit.

### INCORPORATION BY REFERENCE

The present application claims priority under 35U.S.C. § 119 to Japanese Patent Application No. 2024-196391 filed on Nov. 11, 2024. The content of the application is incorporated herein by reference in its entirety.

### BACKGROUND OF THE INVENTION

### Field of the Invention

The present invention relates to a vehicle notification apparatus, a method of controlling a vehicle notification apparatus, and a recording medium.

### Description of the Related Art

Conventionally, there has been known a technology of performing notification to a vehicle driver.

For example, Japanese Patent Laid-Open No. 2020-095421 discloses an information presentation system that transmits information through a sense of a driver. In the information presentation system disclosed by Japanese Patent Laid-Open No. 2020-095421, among senses of sight, hearing, and touch, order of priority of the senses via which information is presented is specified, based on driver information, such as a dozing state, and environmental information, such as a traffic jam.

Incidentally, when a passenger notifies the existence of an object existing around a vehicle to the driver of the vehicle, it is conceivable that the passenger gives different stimuli in different order, according to a degree of risk of the vehicle coming into contact with the object.

For example, when the degree of risk of the vehicle coming into contact with the object is low, it is conceivable that the passenger communicates the existence of the object to the driver with words, and then points at the position of the object with a finger. In the case of such an example, the driver is given stimuli from the passenger in the order of the auditory stimulus, the visual stimulus.

For example, when the degree of risk of the vehicle coming into contact with the object is high, it is conceivable that the passenger tapped the driver in the shoulder in order to make the object to be noticed quickly, then points at the position of the object with a finger, and then communicates the existence of the object with words. In the case of such an example, the driver is given stimuli from the passenger in the order of the tactile stimulus, the visual stimulus, the auditory stimulus.

As in the examples, it is conceivable that a passenger gives a driver different stimuli in different order, according to the degree of risk of the vehicle coming into contact with an object. Accordingly, when the existence of an object around the vehicle is notified through a sense as in Japanese Patent Laid-Open No. 2020-095421, it is preferable to take into consideration the degree of risk of contact. The reason is that it is possible to realize notification that does not cause a driver to feel strange. However, conventionally, there has not been a mechanism that can realize such notification.

Accordingly, an object of the present invention is to make it possible to restrain a driver from feeling strange about notification of the existence of an object around a vehicle. Ultimately, a contribution is made to further improvement in traffic safety, and development of sustainable transportation systems.

### SUMMARY OF THE INVENTION

An aspect of the present invention is a vehicle notification apparatus including: an object detection unit that detects an object existing around a vehicle; a first notification unit that notifies existence of the object around the vehicle to a driver of the vehicle via a sound or voice; a second notification unit that notifies the existence of the object around the vehicle to the driver via a mode other than the sound and voice; and a decision unit that decides notification order between the first notification unit and the second notification unit, according to a degree of risk of the vehicle coming into contact with the object detected by the object detection unit, wherein the first notification unit and the second notification unit perform notification in accordance with the notification order decided by the decision unit.

According to the aspect of the present invention, it is possible to restrain a driver from feeling strange about notification of the existence of an object around a vehicle.

### BRIEF DESCRIPTION OF THE DRAWINGS

FIG. 1 shows a configuration of a vehicle;

FIG. 2 shows a configuration in a vehicle cabin of the vehicle;

FIG. 3 shows a configuration of a vehicle notification apparatus;

FIG. 4 is a diagram for describing decision of a position to display a visual sign;

FIG. 5 is a flowchart showing operation of the vehicle notification apparatus; and

FIG. 6 is a diagram for describing a specific example of notification by the vehicle notification apparatus.

### DETAILED DESCRIPTION OF THE INVENTION

Hereinafter, an embodiment is described with reference to the drawings.

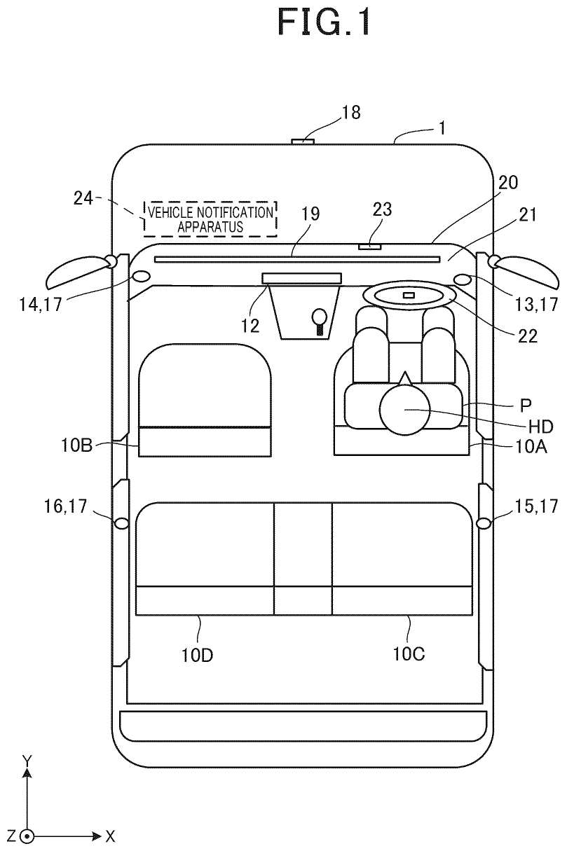

In FIGS. 1, 2, and 4, an X-axis, a Y-axis, and a Z-axis are shown. The X-axis, the Y-axis, and the Z-axis are orthogonal to each other. The Z-axis indicates an up-down direction. The X-axis and the Y-axis are parallel to a horizontal direction in a state where a vehicle 1 is traveling. The X-axis indicates a right-left direction as a vehicle width direction. The Y-axis indicates a front-rear direction. A positive direction of the X-axis indicates a rightward direction. A positive direction of the Y-axis indicates a forward direction. A positive direction of the Z-axis indicates an upward direction.

### 1. Configuration of Vehicle

FIG. 1 shows a configuration of the vehicle 1.

The vehicle 1 illustrated in FIG. 1 is a four-wheel automobile. The vehicle 1 includes a driver seat 10A, a passenger seat 10B, a right rear seat 10C, and a left rear seat 10D. The vehicle 1 in FIG. 1 shows a situation in which a driver P is sitting in the driver seat 10A.

The vehicle 1 includes a touch panel 12. The touch panel 12 is configured by using a display panel that displays a letter, a character, and an image, and a touch sensor that detects a touch on the display panel, which are configured in a superposed manner or as one unit.

The vehicle 1 includes speakers 13, 14, 15, 16. The speaker 13 outputs sound to the driver P sitting in the driver seat 10A. The speaker 14 outputs sound to a passenger sitting in the passenger seat 10B. The speaker 15 outputs sound to a passenger sitting in the right rear seat 10C. The speaker 16 outputs sound to a passenger sitting in the left rear seat 10D. Note that installation positions of the speakers 13, 14, 15, 16 are not limited to those shown in FIG. 1, and may be any positions at which sound can be outputted to occupants sitting in the corresponding seats.

Hereinafter, when no differentiation is made, the speakers 13, 14, 15, 16 are presented as “speakers 17” with sign “17” added.

The vehicle 1 includes a front camera 18 that captures a scene in front of the vehicle 1. The front camera 18 is installed in a front portion of the vehicle 1 and captures a scene in front of the vehicle 1. The front camera 18 performs capturing in each predetermined period when an ignition of the vehicle 1 is on, when an accessory power supply of the vehicle 1 is on, or the like. Each time the front camera 18 performs capturing, the front camera 18 outputs image data on a captured image (hereinafter, referred to as “front captured image”) acquired by the capturing to a vehicle notification apparatus 24.

The vehicle 1 includes an LED (Light Emitting Diode) array 19 extending in the vehicle width direction. The LED array 19 includes a plurality of LEDs. The LED array 19 displays an image on a windshield 20 by projecting light onto the windshield 20.

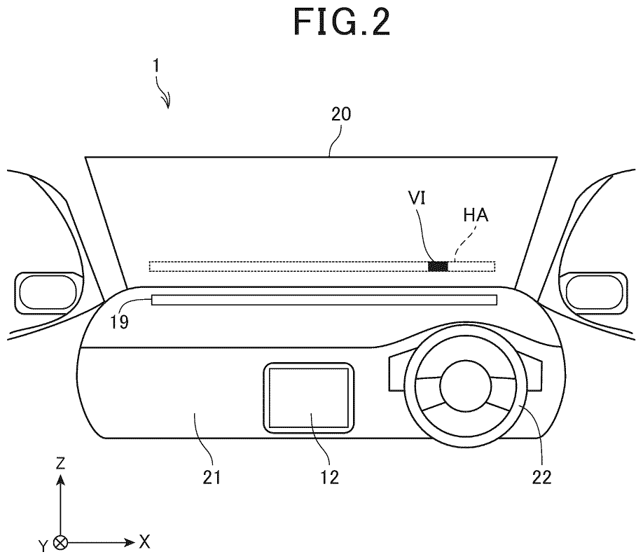

Here, with reference to FIG. 2, a description is given of the LED array 19.

FIG. 2 shows a configuration in a vehicle cabin of the vehicle 1.

An instrument panel 21 is installed in the vehicle cabin of the vehicle 1 shown in FIG. 2. The LED array 19 is installed in a front portion of an upper face of the instrument panel 21. Note that in the instrument panel 21, a steering wheel 22 for steering the vehicle 1, the touch panel 12, and the speaker 13 are installed.

The LED array 19 displays a visual sign VI, which is a virtual image, in a lower portion of the windshield 20 by projecting light onto the windshield 20. The LED array 19 displays the visual sign VI on the windshield 20, whereby the driver P sitting in the driver seat 10A can see the visual sign VI together with a scene in front of the vehicle 1 through the windshield 20.

The displayed visual sign VI is an image extending in the vehicle width direction in the windshield 20. The LED array 19 varies the display position of the visual sign VI by causing different LEDs to project light.

A display area HA of the visual sign VI is formed in an extending manner in the lower portion of the windshield 20. A length of the display area HA in the vehicle width direction corresponds to a length of the LED array 19 in the vehicle width direction. A length of the display area HA in a direction intersecting with the vehicle width direction corresponds to a length of the LED array 19 in the front-rear direction.

A below-mentioned second notification unit 106 performs operation, which will be described later, whereby the visual sign VI is displayed in the display area HA in such a manner that the visual sign VI coincides with an object 2 existing in front of the vehicle 1, or the position of the visual sign VI agrees with the position of the object 2 in the horizontal direction, when seen from the driver P sitting in the driver seat 10A.

Returning to the description of FIG. 1, the vehicle 1 includes a driver monitoring camera 23. The driver monitoring camera 23 is a camera installed at a predetermined position in the vehicle cabin of the vehicle 1 and capturing the driver P sitting in the driver seat 10A. The capturing range of the driver monitoring camera 23 is a range including at least a head HD of the driver P sitting in the driver seat 10A. The driver monitoring camera 23 performs capturing in each predetermined period when the ignition of the vehicle 1 is on, when the accessory power supply of the vehicle 1 is on, or the like. Each time the driver monitoring camera 23 performs capturing, the driver monitoring camera 23 outputs image data on a captured image (hereinafter, referred to as “driver captured image”) acquired by the capturing to the vehicle notification apparatus 24.

The vehicle 1 includes the vehicle notification apparatus 24. The vehicle notification apparatus 24 is an apparatus that performs notification to the driver P by using the speakers 17, the LED array 19, and the steering wheel 22.

### 2. Configuration of Vehicle Notification Apparatus

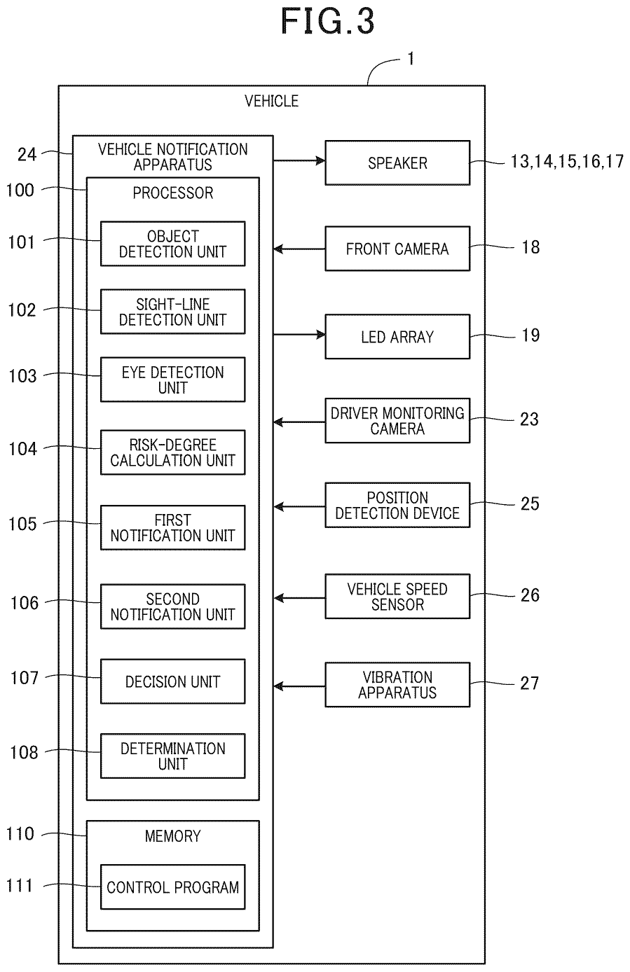

FIG. 3 shows a configuration of the vehicle notification apparatus 24.

The vehicle notification apparatus 24 includes a processor 100, such as a CPU (Central Processing Unit) or an MPU (Micro-Processing Unit), memory 110, and interface circuitry to which another device and sensors are connected.

The processor 100 controls each unit of the vehicle notification apparatus 24 by reading and executing a control program 111 stored in the memory 110. The processor 100 functions as an object detection unit 101, a sight-line detection unit 102, an eye detection unit 103, a risk-degree calculation unit 104, a first notification unit 105, a second notification unit 106, a decision unit 107, and a determination unit 108 by executing the control program 111 stored in the memory 110.

The memory 110 is a storage device that stores a program to be executed by the processor 100 and data to be processed by the processor 100. The memory 110 stores the control program 111 to be executed by the processor 100 and other various data. The memory 110 includes a non-volatile storage area. Moreover, the memory 110 includes a volatile storage area, which constitutes a work area for the processor 100. The memory 110 is configured by using, for example, a ROM (Read Only Memory) and a RAM (Random Access Memory).

The control program 111 corresponds to “program”.

The speakers 17, the front camera 18, the LED array 19, the driver monitoring camera 23, a position detection device 25, a vehicle speed sensor 26, and a vibration apparatus 27 are connected to the vehicle notification apparatus 24. Note that devices connected to the vehicle notification apparatus 24 are not limited to those mentioned above, and a vehicle-to-vehicle communication apparatus for vehicle-to-vehicle communication and other devices, such as a GNSS (Global Navigation Satellite System) unit and a rear camera, may be connected.

The position detection device 25 is a device that can detect a position of an object 2 existing around the vehicle 1. The position detection device 25 is configured by using at least one or more of, for example, a sonar, a radar, lidar, all of which can measure the distance between the vehicle 1 and the object 2, a stereo camera, which can measure the distance between the vehicle 1 and the object by using parallax, and the like.

The vehicle speed sensor 26 is a sensor that detects the speed of the vehicle 1. The vehicle speed sensor 26 detects the speed of the vehicle 1 in each predetermined period and, each time the vehicle speed sensor 26 detects a speed, outputs a signal corresponding to the detected speed of the vehicle 1 to the vehicle notification apparatus 24.

The vibration apparatus 27 is an apparatus (vibrator) that vibrates the steering wheel 22.

As mentioned above, the processor 100 of the vehicle notification apparatus 24 functions as the object detection unit 101, the sight-line detection unit 102, the eye detection unit 103, the risk-degree calculation unit 104, the first notification unit 105, the second notification unit 106, the decision unit 107, and the determination unit 108.

### 2-1. Object Detection Unit

The object detection unit 101 detects an object 2 existing in front of the vehicle 1. Examples of the object 2 include another vehicle, a pedestrian, a fixed object, and the like. For example, the object detection unit 101 detects the object 2 appearing in a front captured image, based on image data received from the front camera 18. The object detection unit 101 detects the object 2 appearing in the front captured image by performing pattern matching or color-based image processing on the front captured image. Note that data (for example, shape data or color data) required to detect the object 2 is stored in the memory 110 by type of object 2 to be detected.

Moreover, the object detection unit 101 detects a position of the detected object 2. More specifically, the object detection unit 101 detects the relative position of the object 2 with respect to the vehicle 1 when the vehicle 1 is viewed from above. The object detection unit 101 detects the relative position of the detected object 2, based on at least any one of a result of detection by the position detection device 25 and the front captured image. Note that when the detected object 2 is another vehicle and when a vehicle-to-vehicle communication apparatus and a GNSS unit are connected to the vehicle notification apparatus 24, the object detection unit 101 may detect the relative position of the detected object 2, based on the position of the other vehicle received by the vehicle-to-vehicle communication apparatus and the position of the vehicle 1 received by the GNSS unit.

Note that apart from the front camera 18, the vehicle-to-vehicle communication apparatus, and the GNSS unit, the object detection unit 101 may use V2X (road-to-vehicle, vehicle-to-pedestrian, or the like) communication or the like to detect the object 2 appearing in the image captured by the front camera 18 and to detect the relative position of the object 2.

Furthermore, the object detection unit 101 detects the type of the detected object 2. For example, the object detection unit 101 detects the type of the object 2, based on the data used to detect the object 2.

When the object 2 is detected, the object detection unit 101 outputs data indicating the relative position of the detected object 2 with respect to the vehicle 1 to the risk-degree calculation unit 104.

Moreover, when the object 2 is detected, the object detection unit 101 outputs data indicating a position of the detected object 2 in the front captured image to the second notification unit 106 and the determination unit 108.

Furthermore, when the type of the object 2 is detected, the object detection unit 101 outputs data indicating the detected type of the object 2 to the first notification unit 105.

### 2-2. Sight-Line Detection Unit

The sight-line detection unit 102 detects the direction of the line of sight of the driver P. The sight-line detection unit 102 detects the direction of the line of sight of the driver P, based on image data received from the driver monitoring camera 23. The sight-line detection unit 102 detects the eyes of the driver P, through pattern matching or based on color or the like, from a driver captured image, and detects a direction in which the detected eyes are pointing as the direction of the line of sight. Note that data (for example, eye shape data or color data) required to detect an eye is stored in the memory 110.

When the direction of the line of sight of the driver P is detected, the sight-line detection unit 102 outputs data indicating the detected direction of the line of sight to the determination unit 108.

### 2-3. Eye Detection Unit

The eye detection unit 103 detects an eye of the driver P sitting in the driver seat 10A. The eye detection unit 103 detects the eye of the driver P, based on image data on a driver captured image. The eye detection unit 103 detects the eye, through pattern matching or based on color or the like, from the driver captured image. Next, the eye detection unit 103 detects a position of the eye in the driver captured image, through pattern matching or based on color or the like. The eye detection unit 103 then detects a position of the eye in the right-left direction in the vehicle 1, based on the position of the eye in the driver captured image. Note that it has been determined, through testing or simulation performed beforehand, what position an eye is at in the right-left direction in the vehicle 1 when what position the eye is at in a driver captured image, and such information is stored as data in the memory 110.

When the position of the eye of the driver P is detected, the eye detection unit 103 outputs data indicating the detected position of the eye to the second notification unit 106.

### 2-4. Risk-Degree Calculation Unit

The risk-degree calculation unit 104 calculates a degree of risk that is a degree of risk of the vehicle 1 coming into contact with an object 2.

For example, the risk-degree calculation unit 104 calculates the separation distance between the vehicle 1 and the object 2, based on data indicating a relative position received from the object detection unit 101. Next, the risk-degree calculation unit 104 calculates an evaluation value corresponding to the calculated separation distance, among evaluation values on multi-point scale, as the degree of risk. In the present embodiment, the degree of risk is any one of evaluation values on 10-point scale ranging from “1” to “10”, and a larger point on the scale (a larger number in double-quotation marks) indicates a higher degree of risk. For example, a degree of risk of “1” indicates that the degree of risk is the lowest. For example, a degree of risk of “10” indicates that the degree of risk is the highest. In the case of such a calculation method, the risk-degree calculation unit 104 calculates a degree of risk corresponding to a larger point on the scale, for a shorter separation distance calculated.

Alternatively, for example, the risk-degree calculation unit 104 calculates the mutual relative velocities of the vehicle 1 and the object 2, based on data indicating a plurality of relative positions received from the object detection unit 101 and a result of detection by the vehicle speed sensor 26. Moreover, the risk-degree calculation unit 104 calculates the separation distance between the vehicle 1 and the object 2, based on data indicating a relative position received from the object detection unit 101. Next, the risk-degree calculation unit 104 calculates a time period (TTC: Time to Collision) required for the vehicle 1 to come into contact with the object 2, based on the calculated relative velocities and separation distance. The risk-degree calculation unit 104 then calculates an evaluation value corresponding to the calculated required time period, among evaluation values on 10-point scale, as the degree of risk. In the case of such a calculation method, the risk-degree calculation unit 104 calculates a degree of risk corresponding to a larger point on the scale, for a shorter required time period calculated.

Alternatively, for example, when a vehicle-to-vehicle communication apparatus and a GNSS unit are connected to the vehicle notification apparatus 24 and when the object 2 detected by the object detection unit 101 is another vehicle, the risk-degree calculation unit 104 may calculate the degree of risk as follows. Specifically, the risk-degree calculation unit 104 calculates the mutual relative velocities of the vehicle 1 and the object 2 and the separation distance between the vehicle 1 and the object 2, based on the speed of the vehicle 1 detected by the vehicle speed sensor 26, the position of the vehicle 1 received by the GNSS unit, and the position of the other vehicle and the speed of the other vehicle received by the vehicle-to-vehicle communication apparatus. Next, the risk-degree calculation unit 104 calculates a time period required for the vehicle 1 to come into contact with the object 2, based on the calculated relative velocities and separation distance. The risk-degree calculation unit 104 then calculates an evaluation value corresponding to the calculated required time period, among evaluation values on 10-point scale, as the degree of risk. In the case of such calculation of a degree of risk, the risk-degree calculation unit 104 calculates a degree of risk corresponding to a larger point on the scale, for a shorter required time period calculated.

Note that the above-described methods of calculating a degree of risk are only examples, and a method of calculating a degree of risk is not limited to the described methods.

When the degree of risk is calculated, the risk-degree calculation unit 104 outputs data indicating the calculated degree of risk to the first notification unit 105, the second notification unit 106, and the decision unit 107.

### 2-5. First Notification Unit

The first notification unit 105 notifies the existence of an object 2 around the vehicle 1 to the driver P via a sound or voice. Here, the sound refers to a sound other than voice, and is a sound, such as a warning sound, that does not indicate any language.

The first notification unit 105 notifies the existence of the object 2 around the vehicle 1 by outputting the sound or voice through the speakers 17. The first notification unit 105 outputs the sound or voice through at least the speaker 13. Note that in addition to the speaker 13, the first notification unit 105 may output the sound or voice from all, or one or some, of the speakers 14, 15, 16.

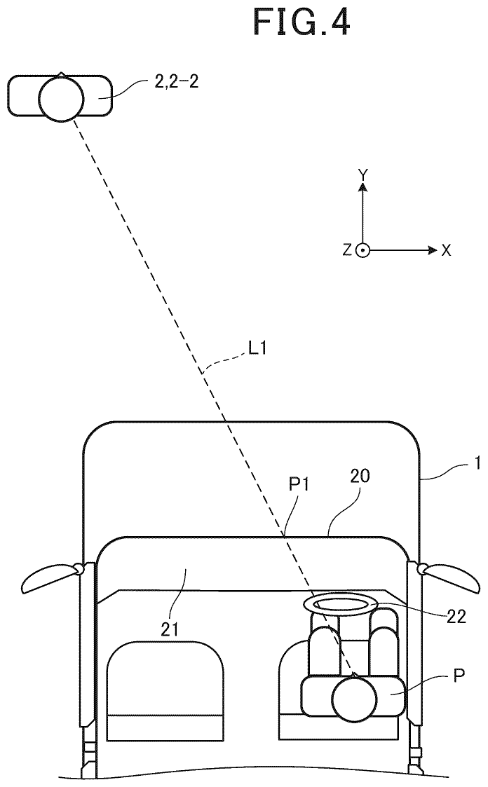

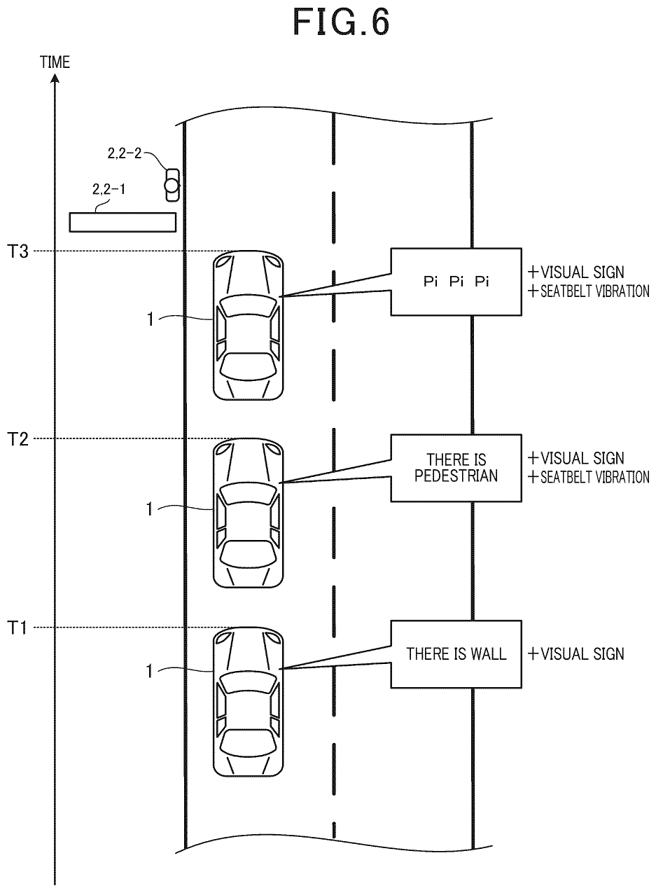

When performing notification via voice, the first notification unit 105 outputs a voice indicating what type of object 2 exists through the speakers 17, based on data on the type of the object 2 received from the object detection unit 101. For example, when the object detection unit 101 detects a pedestrian 2-2 (see FIGS. 4, 6) as a type of object 2, the first notification unit 105 outputs a voice saying “there is a pedestrian” through the speakers 17. For example, when the object detection unit 101 detects another vehicle as a type of object 2, the first notification unit 105 outputs a voice saying “there is another vehicle” through the speakers 17. For example, when the object detection unit 101 detects a wall 2-1 (see FIG. 6) as an object 2, the first notification unit 105 outputs a voice saying “there is a wall” through the speakers 17.

### 2-6. Second Notification Unit

The second notification unit 106 notifies the existence of an object 2 around the vehicle 1 to the driver P via a mode other than a sound and voice. In the present embodiment, the second notification unit 106 performs notification via a tactile stimulus and a visual stimulus.

The second notification unit 106 notifies the existence of the object 2 around the vehicle 1 via the tactile stimulus by causing the vibration apparatus 27 to operate and thereby vibrating the steering wheel 22.

The second notification unit 106 notifies the existence of the object 2 around the vehicle 1 via the visual stimulus by controlling the LED array 19 and thereby displaying the visual sign VI on the windshield 20. The second notification unit 106 displays the visual sign VI on the windshield 20 by performing following processing.

When displaying the visual sign VI, the second notification unit 106 decides a position to display the visual sign VI in the right-left direction of the vehicle 1.

FIG. 4 is a diagram for describing the decision of a position to display the visual sign VI.

FIG. 4 illustrates, as the object 2, a pedestrian 2-2 existing in front of the vehicle 1.

The second notification unit 106 detects, in a view of the vehicle 1 from above, a position at which a line connecting the position of the eye of the driver P and the position of the object 2 intersects with the windshield 20 in the right-left direction of the vehicle 1. The second notification unit 106 detects the position in the right-left direction at which the line connecting the position of the eye and the position of the object 2 intersects with the windshield 20, based on the relative position of the object 2 detected by the object detection unit 101 and the position of the eye detected by the eye detection unit 103.

In FIG. 4, a line L1 is the line connecting the position of the eye and the position of the object 2 in the view of the vehicle 1 from above. In the case of FIG. 4, the second notification unit 106 detects a position P1 in the right-left direction at which the line L1 intersects with the windshield 20 in the view of the vehicle 1 from above. In the case of FIG. 4, the second notification unit 106 then decides that the detected position P1 is the position to display the visual sign VI.

When the position to display the visual sign VI is decided, the second notification unit 106 causes the LED array 19 to display the visual sign VI at the decided position. The second notification unit 106 turns on an LED corresponding to the decided position to display the visual sign VI, whereby the visual sign VI is displayed at the decided position to display the visual sign VI.

### 2-7. Decision Unit

The decision unit 107 decides notification order between the first notification unit 105 and the second notification unit 106, based on a degree of risk calculated by the risk-degree calculation unit 104.

When the degree of risk calculated by the risk-degree calculation unit 104 exceeds a first threshold value, the decision unit 107 decides that the notification order is the first notification unit 105, followed by the second notification unit 106. An example of the first threshold value is “8”. Note that a first threshold value of “8” is only an example, and the first threshold value is not limited to this value.

The first threshold value is an example of “predetermined value”.

When the degree of risk calculated by the risk-degree calculation unit 104 is the first threshold value or less and exceeds a second threshold value, the decision unit 107 decides that the notification order is the second notification unit 106, followed by the first notification unit 105. The second threshold value is a value less than the first threshold value, and an example thereof is “4”. Note that a second threshold value of “4” is only an example, and the second threshold value is not limited to this value.

When the degree of risk calculated by the risk-degree calculation unit 104 is the second threshold value or less, the decision unit 107 decides that the notification order is the first notification unit 105, followed by the second notification unit 106.

### 2-8. Determination Unit

The determination unit 108 determines whether or not the driver P has perceived an object 2 detected by the object detection unit 101. The determination unit 108 determines whether or not the driver P has perceived the object 2 detected by the object detection unit 101, based on the direction of the line of sight of the driver P detected by the sight-line detection unit 102. The determination unit 108 determines whether or not the line of sight of the driver P is directed to the object 2 detected by the object detection unit 101, based on the relative position of the object 2 indicated by data received from the object detection unit 101, and the direction of the line of sight of the driver P indicated by data received from the sight-line detection unit 102. When the determination unit 108 determines that the line of sight of the driver P is directed to the object 2 detected by the object detection unit 101, the determination unit 108 determines that the driver P has perceived the object 2 detected by the object detection unit 101. When the determination unit 108 determines that the line of sight of the driver P is not directed to the object 2 detected by the object detection unit 101, the determination unit 108 determines that the driver P does not perceive the object 2 detected by the object detection unit 101.

Note that the determination unit 108 may determine whether or not the driver P has perceived the object 2 detected by the object detection unit 101, based on voice collected by an undepicted interior microphone. When the voice collected by the interior microphone includes wording indicating that the object 2 is perceived, the determination unit 108 determines that the driver P has perceived the object 2 detected by the object detection unit 101, and otherwise, determines that the driver P does not perceive the object 2 detected by the object detection unit 101. For example, when the interior microphone collects a voice saying “there is a pedestrian”, “pay attention to a pedestrian”, or the like, the determination unit 108 determines that the driver P has perceived the object 2 detected by the object detection unit 101.

### 3. Operation of Vehicle Notification Apparatus

Next, operation of the vehicle notification apparatus 24 according to the present embodiment is described.

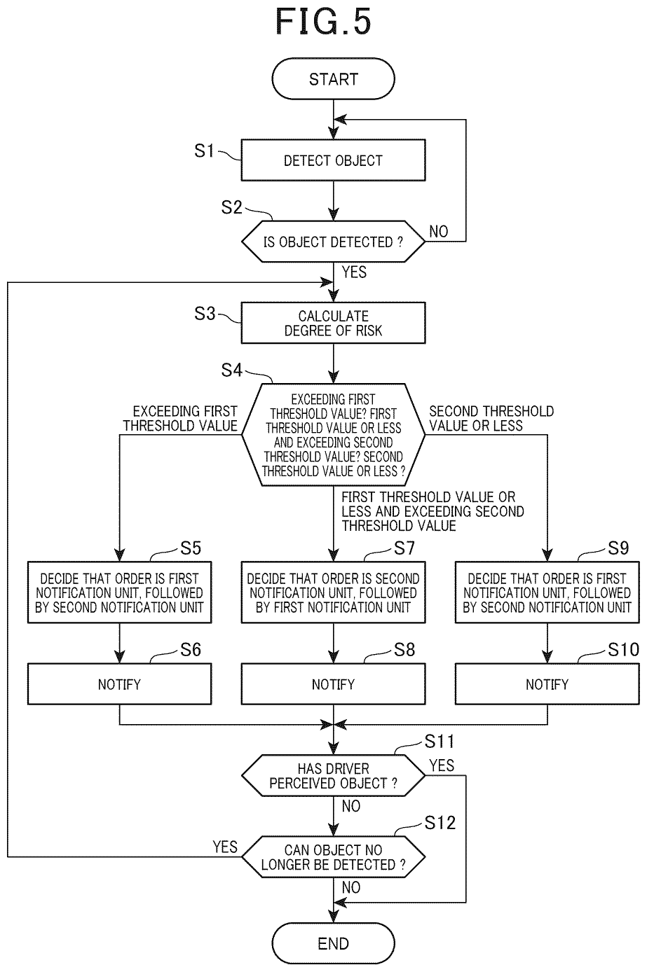

FIG. 5 is a flowchart showing the operation of the vehicle notification apparatus 24.

The object detection unit 101 detects an object 2 existing around the vehicle 1 (step S1).

Step S1 corresponds to “detection step”.

Next, the risk-degree calculation unit 104 determines whether or not an object 2 is detected in step S1 (step S2). The determination in step S2 is performed based on whether or not data is received from the object detection unit 101.

Next, when the risk-degree calculation unit 104 determines that an object 2 is not detected in step S1 (step S2: NO), the processor 100 returns the processing to step S1, and the process in step S1 is performed again.

When it is determined that an object 2 is detected in step S1 (step S2: YES), the risk-degree calculation unit 104 calculates a degree of risk (step S3).

Next, the decision unit 107 determines whether the degree of risk calculated in step S3 exceeds the first threshold value, or is the first threshold value or less and exceeds the second threshold value, or is the second threshold value or less (step S4).

When the decision unit 107 determines that the degree of risk calculated in step S3 exceeds the first threshold value (step S4: EXCEEDING FIRST THRESHOLD VALUE), the decision unit 107 decides that the notification order is the first notification unit 105, followed by the second notification unit 106 (step S5).

Step S5 corresponds to “decision step”.

Next, the first notification unit 105 and the second notification unit 106 perform notification in the notification order decided in step S5 (step S6).

Step S6 corresponds to “notification step”.

Step S6 is described in detail.

First, the first notification unit 105 performs notification via a sound. Next, the second notification unit 106 performs notification via the tactile stimulus. Then, the second notification unit 106 performs notification via the visual stimulus. In other words, in step S6, the processor 100 performs notification by giving stimuli to the driver P in the order of the auditory stimulus, the tactile stimulus, the visual stimulus. Note that the second notification unit 106 performs notification via the visual stimulus by displaying the visual sign VI at a position corresponding to the object 2 detected in step S1.

It is assumed that degrees of risk felt by a passenger are broadly divided into three levels of “high”, “medium”, “low”. A “high” degree of risk indicates that the degree of risk is more than a “medium” degree of risk. The “medium” degree of risk indicates that the degree of risk is more than a “low” degree of risk. In such a case, when the degree of risk is “high”, it is conceivable that in order to make an object 2 to be noticed as quickly as possible, the passenger communicates the existence of the object 2 to the driver P with short words, touches the driver P almost at the same time as the communication, and then points at the position of the object 2 with a finger almost at the same time as the touch. Accordingly, when the degree of risk exceeds the first threshold value, the vehicle notification apparatus 24 performs notification via stimuli in order modeled after human behavior, by giving the stimuli to the driver P in the order of the auditory stimulus, the tactile stimulus, the visual stimulus. Accordingly, the vehicle notification apparatus 24 can restrain the driver P from feeling strange about notification of the existence of the object 2 around the vehicle 1. Moreover, when the degree of risk exceeds the first threshold value, the vehicle notification apparatus 24 performs notification via a sound, not voice. Thus, the probability can be enhanced that the driver P can perceive the existence of the object around the vehicle 1 more quickly than understanding voice and then comprehending the meaning of notification.

Returning to the description of step S4, when the decision unit 107 determines that the degree of risk calculated in step S3 is the first threshold value or less and exceeds the second threshold value (step S4: FIRST THRESHOLD VALUE OR LESS AND EXCEEDING SECOND THRESHOLD VALUE), the decision unit 107 decides that the notification order is the second notification unit 106, followed by the first notification unit 105 (step S7).

Step S7 corresponds to “decision step”.

Next, the first notification unit 105 and the second notification unit 106 perform notification in the notification order decided in step S7 (step S8).

Step S8 corresponds to “notification step”.

Step S8 is described in detail.

First, the second notification unit 106 performs notification via the tactile stimulus. Next, the second notification unit 106 performs notification via the visual stimulus. Then, the first notification unit 105 performs notification via voice. In other words, in step S8, the processor 100 performs notification by giving stimuli to the driver P in the order of the tactile stimulus, the visual stimulus, the auditory stimulus. Note that the second notification unit 106 performs notification via the visual stimulus by displaying the visual sign VI at a position corresponding to the object 2 detected in step S1.

It is assumed that degrees of risk felt by a passenger are broadly divided into three levels of “high”, “medium”, “low”. In such a case, when the degree of risk is “medium”, it is conceivable that in order to make an object 2 to be noticed quickly, the passenger touches the driver P, then points at the position of the object with a finger, and then communicates the existence of the object 2 to the driver P with words. Accordingly, when the degree of risk is the first threshold value or less and exceeds the second threshold value, the vehicle notification apparatus 24 can perform notification via stimuli in order modeled after human behavior, by giving the stimuli to the driver P in the order of the tactile stimulus, the visual stimulus, the auditory stimulus. Accordingly, the vehicle notification apparatus 24 can restrain the driver P from feeling strange about notification of the existence of the object 2 around the vehicle 1.

Returning to the description of step S4, when the decision unit 107 determines that the degree of risk calculated in step S3 is the second threshold value or less (step S4: SECOND THRESHOLD VALUE OR LESS), the decision unit 107 decides that the notification order is the first notification unit 105, followed by the second notification unit 106 (step S9).

Step S9 corresponds to “decision step”.

Next, the first notification unit 105 and the second notification unit 106 perform notification in the notification order decided in step S9 (step S10).

Step S10 corresponds to “notification step”.

Step S10 is described in detail.

First, the first notification unit 105 performs notification via voice. Next, the second notification unit 106 performs notification via the visual stimulus. In other words, in step S6, the processor 100 performs notification by giving stimuli to the driver P in the order of the auditory stimulus, the visual stimulus. Note that the second notification unit 106 performs notification via the visual stimulus by displaying the visual sign VI at a position corresponding to the object 2 detected in step S1.

It is assumed that degrees of risk felt by a passenger are broadly divided into three levels of “high”, “medium”, “low”. In such a case, when the degree of risk is “low”, it is conceivable that in order to make an object 2 to be noticed beforehand, the passenger communicates the existence of the object 2 to the driver P with words, and then points at the position of the object 2 with a finger. Accordingly, when the degree of risk is the second threshold value or less, the vehicle notification apparatus 24 can perform notification via stimuli in order modeled after human behavior, by giving the stimuli to the driver P in the order of the auditory stimulus, the visual stimulus. Accordingly, the vehicle notification apparatus 24 can restrain the driver P from feeling strange about notification of the existence of the object 2 around the vehicle 1.

Next, the determination unit 108 determines whether or not the driver P has perceived the object 2 detected in step S1 (step S11).

When the determination unit 108 determines that the driver P has perceived the object 2 detected in step S1 (step S11: YES), the processor 100 terminates the present processing. In other words, the processor 100 ceases notification with regard to the object 2 detected in step S1.

When the determination unit 108 determines that the driver P does not perceive the object 2 detected in step S1 (step S11: NO), the object detection unit 101 determines whether or not the object 2 detected in step S1 can no longer be detected (step S12).

When it is determined that the object 2 can still be detected (step S12: YES), the processor 100 returns the processing to step S3, and the processes in and after step S3 are performed again.

When it is determined that the object 2 can no longer be detected (step S12: NO), the processor 100 terminates the present processing.

With reference to FIG. 6, a specific example of the flowchart shown in FIG. 5 is described.

FIG. 6 is a diagram for describing the specific example of notification by the vehicle notification apparatus 24.

FIG. 6 illustrates a case in which the vehicle 1 is traveling from the bottom of the drawing toward the top thereof. Moreover, FIG. 6 illustrates a case in which a wall 2-1 and a pedestrian 2-2 exist on the left side with respect to the traveling direction of the vehicle 1.

Time T1 shown in FIG. 6 is a time at which the object detection unit 101 detects the wall 2-1 as an object 2. In FIG. 6, it is assumed that at time T1, the degree of risk with regard to the wall 2-1 is the second threshold value or less. When the wall 2-1 is detected at time T1, the vehicle notification apparatus 24 performs the process in step S10. Specifically, the vehicle notification apparatus 24 performs notification via voice by outputting a voice saying “there is a wall” through the speakers 17. After the notification, the vehicle notification apparatus 24 performs notification via the visual stimulus by displaying the visual sign VI through the LED array 19.

Time T2 shown in FIG. 6 is a time at which the object detection unit 101 detects the pedestrian 2-2 as an object 2. Time T2 shown in FIG. 6 is a time after the driver P directs the line of sight to the wall 2-1. In FIG. 6, it is assumed that at time T2, the degree of risk with regard to the pedestrian 2-2 is the first threshold value or less and exceeds the second threshold value. When the pedestrian 2-2 is detected at time T2, the vehicle notification apparatus 24 performs the process in step S8. Specifically, the vehicle notification apparatus 24 performs notification via the tactile stimulus by vibrating the steering wheel 22 through the vibration apparatus 27. After the notification, the vehicle notification apparatus 24 performs notification via the visual stimulus by displaying the visual sign VI through the LED array 19. After the notification, the vehicle notification apparatus 24 performs notification via voice by outputting a voice saying “there is a pedestrian” or “there is a pedestrian behind a wall” through the speakers 17.

Time T3 shown in FIG. 6 is a time at which the degree of risk with regard to the pedestrian 2-2 detected at time T2 exceeds the first threshold value. At time T3, the vehicle notification apparatus 24 performs the process in step S6. Specifically, the vehicle notification apparatus 24 performs notification via a sound. Thereafter, the vehicle notification apparatus 24 performs notification via the tactile stimulus by vibrating the steering wheel 22 through the vibration apparatus 27. After the notification, the vehicle notification apparatus 24 performs notification via the visual stimulus by displaying the visual sign VI through the LED array 19.

### 4. Other Embodiments

The embodiment described above illustrates only an aspect, and any modifications and applications can be made.

Although the first threshold value is illustrated as “predetermined value” in the embodiment, “predetermined value” may be the “second threshold value”.

In the embodiment, a configuration is made such that the second notification unit 106 performs notification via the tactile stimulus by causing the steering wheel 22 to vibrate. In another embodiment, a configuration may be made such that the second notification unit 106 performs notification via the tactile stimulus by causing seatbelt tension to be changed. In the case of the another embodiment, at least the driver seat 10A is equipped with an electric seatbelt. In still another embodiment, a configuration may be made such that the second notification unit 106 performs notification via the tactile stimulus by causing the driver seat 10A to vibrate. In the case of the still another embodiment, an apparatus that vibrates the driver seat 10A is connected to the vehicle notification apparatus 24.

In the embodiment, a configuration is made such that the second notification unit 106 performs notification via the visual stimulus when the degree of risk is the second threshold value or less. In another embodiment, when the degree of risk is the second threshold value or less, the second notification unit 106 may perform notification via the tactile stimulus after performing notification via the visual stimulus.

In the embodiment, a configuration is made such that notification by outputting voice is not performed when the degree of risk exceeds the first threshold value. In another embodiment, when the degree of risk exceeds the first threshold value, the first notification unit 105 may perform notification via voice after the second notification unit 106 performs notification. Thus, when the driver P ruminates about the notification by the first notification unit 105 and the second notification unit 106, the probability can be enhanced that the driver P can understand why such notification is made, so that it is possible to restrain the driver P from feeling strange about notification for the next time onward.

In another embodiment, the frequency of a voice outputted when the degree of risk is the first threshold value or less and exceeds the second threshold value may be set lower, or the speech rate of the voice may be set faster, than that of a voice outputted when the degree of risk is the second threshold value or less.

Although the vehicle 1 that is a four-wheel automobile is illustrated as “vehicle” in the embodiment, the number of wheels is not limited to four as long as the “vehicle” includes a windshield 20.

In the embodiment, a configuration is made such that a degree of risk is calculated based on an evaluation value on 10-point scale. In another embodiment, the number of points on the scale for degrees of risk to be calculated is not limited to 10, and the number of points on the scale may be smaller than 10, or may be larger than 10.

In the embodiment, a configuration is made such that the LED array 19 is used to display the visual sign VI on the windshield 20. In another embodiment, the visual sign VI may be displayed on the windshield 20 through another method, such as a projector or a head-up display.

In the embodiment, a configuration is made such that notification via the visual stimulus is performed by displaying an image on the windshield 20. In another embodiment, notification via the visual stimulus may be performed by causing a light-emitting part, such as a light, provided in the vehicle cabin to emit light. In the case of the another embodiment, a light-emitting part is provided in each of right, left, and middle portions of the vehicle 1 in the vehicle cabin, and any one of the light-emitting parts is caused to emit light, according to the position of an object 2 with respect to the vehicle 1.

The configuration as to each unit of the vehicle 1 shown in FIG. 3 is an example, and a specific implementation form is not limited particularly. In other words, an individual corresponding hardware piece does not necessarily need to be mounted for each unit, and it is also certainly possible to make a configuration such that the function of each unit is implemented by a single processor executing a program. In the embodiment, one or some of the functions implemented by using software may be configured as hardware, or alternatively, one or some of the functions implemented by hardware may be implemented by using software.

Moreover, the step units of operation shown in FIG. 5 are created by division according to main processes, and the present invention is not limited by a way of division into, or by names of, units of processing. The operation may be divided into more step units according to processes. A step unit may be divided to include more sub-processes. The order of steps may be interchanged as appropriate to the extent that the gist of the present invention is not impaired.

When a method of controlling the vehicle notification apparatus 24 is implemented by using the processor 100, the program to be executed by the processor 100 can also be configured in the form of a recording medium or a transmission medium transmitting the program. In other words, the control program 111 can also be implemented in a state in which the control program 111 is recorded on a removable information recording medium. Examples of the information recording medium include magnetic recording media such as hard disk, optical recording media such as CD, and semiconductor storage devices such as USB (Universal Serial Bus) memory and SSD (Solid State Drive). Any other recording medium can also be used.

The embodiment supports following configurations.

### Configuration 1

A vehicle notification apparatus, including: an object detection unit that detects an object existing around a vehicle; a first notification unit that notifies existence of the object around the vehicle to a driver of the vehicle via voice or a sound other than voice; a second notification unit that notifies the existence of the object around the vehicle to the driver via a mode other than voice and the sound; and a decision unit that decides notification order between the first notification unit and the second notification unit, according to a degree of risk of the vehicle coming into contact with the object detected by the object detection unit, wherein the first notification unit and the second notification unit perform notification in accordance with the notification order decided by the decision unit.

According to the vehicle notification apparatus in configuration 1, since the notification order between notification via voice or the sound other than voice and notification via the mode other than voice and the sound can be changed according to the degree of risk, a way of receiving notification can be varied according to the degree of risk of the vehicle coming into contact with the object. Accordingly, it is possible to restrain the driver from feeling strange about notification of the existence of the object around the vehicle.

### Configuration 2

The vehicle notification apparatus according to configuration 1, wherein the first notification unit performs notification via the sound when the degree of risk exceeds a predetermined value, and performs notification via voice when the degree of risk is the predetermined value or less.

According to the vehicle notification apparatus in configuration 2, when the degree of risk of the vehicle coming into contact with the object is low, notification is performed via voice. Accordingly, the driver can correctly perceive the existence of the object around the vehicle. Moreover, according to the vehicle notification apparatus in configuration 2, when the degree of risk is high, notification is performed via the sound other than voice. Accordingly, the probability can be enhanced that the driver can perceive the existence of the object around the vehicle more quickly than understanding voice and then comprehending the meaning of notification.

### Configuration 3

The vehicle notification apparatus according to configuration 2, wherein the decision unit decides the notification order, according to whether the degree of risk exceeds a first threshold value, or is the first threshold value or less and exceeds a second threshold value, or is the second threshold value or less, the second threshold value being less than the first threshold value.

According to the vehicle notification apparatus in configuration 3, degrees of risk can be divided into three levels, and the notification order can be decided. Accordingly, at each of the three levels of degrees of risk, it is possible to restrain the driver from feeling strange about notification.

### Configuration 4

The vehicle notification apparatus according to configuration 3, wherein when the degree of risk exceeds the first threshold value, the decision unit decides that the notification order is the first notification unit, followed by the second notification unit, and the second notification unit is able to perform notification via a tactile stimulus and a visual stimulus, and performs notification in order of notification via the tactile stimulus, notification via the visual stimulus.

When the degree of risk is at the highest level of the three levels, it is conceivable that in order to make the object to be noticed as quickly as possible, a passenger communicates the existence of the object to the driver with short words, touches the driver almost at the same time as the communication, and then points at the position of the object with a finger almost at the same time as the touch. Accordingly, when the degree of risk exceeds the first threshold value, the vehicle notification apparatus in configuration 4 can perform notification via stimuli in order modeled after human behavior, by giving the stimuli to the driver in the order of the auditory stimulus, the tactile stimulus, the visual stimulus. Accordingly, the vehicle notification apparatus in configuration 4 can restrain the driver from feeling strange about notification of the existence of the object around the vehicle.

### Configuration 5

The vehicle notification apparatus according to configuration 3, wherein when the degree of risk is the first threshold value or less and exceeds the second threshold value, the decision unit decides that the notification order is the second notification unit, followed by the first notification unit, and the second notification unit is able to perform notification via a tactile stimulus and a visual stimulus, and performs notification in order of notification via the tactile stimulus, notification via the visual stimulus.

When the degree of risk is at the middle level of the three levels, it is conceivable that in order to make the object to be noticed quickly, a passenger touches the driver, then points at the position of the object with a finger, and then communicates the existence of the object to the driver with words. Accordingly, when the degree of risk is the first threshold value or less and exceeds the second threshold value, the vehicle notification apparatus in configuration 5 can perform notification via stimuli in order modeled after human behavior, by giving the stimuli to the driver in the order of the tactile stimulus, the visual stimulus, the auditory stimulus. Accordingly, the vehicle notification apparatus in configuration 5 can restrain the driver from feeling strange about notification of the existence of the object around the vehicle.

### Configuration 6

The vehicle notification apparatus according to configuration 3, wherein when the degree of risk is the second threshold value or less, the decision unit decides that the notification order is the first notification unit, followed by the second notification unit, and the second notification unit performs notification to the driver via a visual stimulus.

When the degree of risk is at the lowest level of the three levels, it is conceivable that in order to make the object to be noticed beforehand, a passenger communicates the existence of the object to the driver with words, and then points at the position of the object with a finger. Accordingly, when the degree of risk is the second threshold value or less, the vehicle notification apparatus in configuration 6 can perform notification via stimuli in order modeled after human behavior, by giving the stimuli to the driver in the order of the auditory stimulus, the visual stimulus. Accordingly, the vehicle notification apparatus in configuration 6 can restrain the driver from feeling strange about notification of the existence of the object around the vehicle.

### Configuration 7

The vehicle notification apparatus according to any one of configurations 1 to 6, further including a determination unit that determines whether or not the driver has perceived the object detected by the object detection unit, wherein when the determination unit determines that the driver has perceived the object after notification is performed to the driver, the first notification unit and the second notification unit cease notification with regard to the notified object.

According to the vehicle notification apparatus in configuration 7, when the object existing around the vehicle has been perceived, notification is not performed again with regard to the object notified once. Accordingly, it is possible to restrain annoyance caused as a result of notification being performed many times with regard to one object.

### Configuration 8

A method of controlling a vehicle notification apparatus, including: a detection step of detecting an object existing around a vehicle; a notification step of notifying existence of the object around the vehicle to a driver of the vehicle through notification via voice or a sound other than voice and through notification via a mode other than voice and the sound; and a decision step of deciding notification order between the notification via voice or the sound and the notification via the mode other than voice and the sound, according to a degree of risk of the vehicle coming into contact with the object detected in the detection step, wherein the notification step performs notification in accordance with the notification order decided in the decision step.

According to the method of controlling the vehicle notification apparatus in configuration 8, similar effects to those of the vehicle notification apparatus in configuration 1 can be brought about.

### Configuration 9

A non-transitory computer readable recording medium recording a program causing a processor to function as: an object detection unit that detects an object existing around a vehicle; a first notification unit that performs notification to a driver of the vehicle via voice or a sound other than voice; a second notification unit that performs notification to the driver via a mode other than voice and the sound; and a decision unit that decides notification order between the first notification unit and the second notification unit, according to a degree of risk of the vehicle coming into contact with the object detected by the object detection unit, wherein the first notification unit and the second notification unit perform notification in accordance with the notification order decided by the decision unit.

According to the recording medium in configuration 9, similar effects to those of the vehicle notification apparatus in configuration 1 can be brought about.

### REFERENCE SIGNS LIST

1 vehicle, 2 object, 2-1 wall, 2-2 pedestrian, 10A driver seat, 10B passenger seat, 10C right rear seat, 10D left rear seat, 12 touch panel, 13, 14, 15, 16, 17 speaker, 18 front camera, 19 LED array, 20 windshield, 21 instrument panel, 22 steering wheel, 23 driver monitoring camera, 24 vehicle notification apparatus, 25 position detection device, 26 vehicle speed sensor, 27 vibration apparatus, 100 processor, 101 object detection unit, 102 sight-line detection unit, 103 eye detection unit, 104 risk-degree calculation unit, 105 first notification unit, 106 second notification unit, 107 decision unit, 108 determination unit, 110 memory, 111 control program (program), HA display area, HD head, L1 line, P driver, P1 position, S1 step (detection step), S2, S3, S4, S11, S12 step, S5, S7, S9 step (decision step), S6, S8, S10 step (notification step), VI visual sign

1. A vehicle notification apparatus, comprising:
an object detection unit that detects an object existing around a vehicle;
a first notification unit that notifies existence of the object around the vehicle to a driver of the vehicle via voice or a sound other than voice;
a second notification unit that notifies the existence of the object around the vehicle to the driver via a mode other than voice and the sound; and
a decision unit that decides notification order between the first notification unit and the second notification unit, according to a degree of risk of the vehicle coming into contact with the object detected by the object detection unit,
wherein the first notification unit and the second notification unit perform notification in accordance with the notification order decided by the decision unit.

2. The vehicle notification apparatus according to claim 1, wherein the first notification unit performs notification via the sound when the degree of risk exceeds a predetermined value, and performs notification via voice when the degree of risk is the predetermined value or less.

3. The vehicle notification apparatus according to claim 1, wherein the decision unit decides the notification order, according to whether the degree of risk exceeds a first threshold value, or is the first threshold value or less and exceeds a second threshold value, or is the second threshold value or less, the second threshold value being less than the first threshold value.

4. The vehicle notification apparatus according to claim 3, wherein
when the degree of risk exceeds the first threshold value, the decision unit decides that the notification order is the first notification unit, followed by the second notification unit, and
the second notification unit is able to perform notification via a tactile stimulus and a visual stimulus, and performs notification in order of notification via the tactile stimulus, notification via the visual stimulus.

5. The vehicle notification apparatus according to claim 3, wherein
when the degree of risk is the first threshold value or less and exceeds the second threshold value, the decision unit decides that the notification order is the second notification unit, followed by the first notification unit, and
the second notification unit is able to perform notification via a tactile stimulus and a visual stimulus, and performs notification in order of notification via the tactile stimulus, notification via the visual stimulus.

6. The vehicle notification apparatus according to claim 3, wherein
when the degree of risk is the second threshold value or less, the decision unit decides that the notification order is the first notification unit, followed by the second notification unit, and
the second notification unit performs notification to the driver via a visual stimulus.

7. The vehicle notification apparatus according to claim 1, further comprising a determination unit that determines whether or not the driver has perceived the object detected by the object detection unit,
wherein when the determination unit determines that the driver has perceived the object after notification is performed to the driver, the first notification unit and the second notification unit cease notification with regard to the notified object.

8. A method of controlling a vehicle notification apparatus, comprising:
a detection step of detecting an object existing around a vehicle;
a notification step of notifying existence of the object around the vehicle to a driver of the vehicle through notification via voice or a sound other than voice and through notification via a mode other than voice and the sound; and
a decision step of deciding notification order between the notification via voice or the sound and the notification via the mode other than voice and the sound, according to a degree of risk of the vehicle coming into contact with the object detected in the detection step,
wherein the notification step performs notification in accordance with the notification order decided in the decision step.

9. A non-transitory computer readable recording medium recording a program causing a processor to function as:
an object detection unit that detects an object existing around a vehicle;
a first notification unit that performs notification to a driver of the vehicle via voice or a sound other than voice;
a second notification unit that performs notification to the driver via a mode other than voice and the sound; and
a decision unit that decides notification order between the first notification unit and the second notification unit, according to a degree of risk of the vehicle coming into contact with the object detected by the object detection unit,
wherein the first notification unit and the second notification unit perform notification in accordance with the notification order decided by the decision unit.
